(19) United States
(12) Patent Application Publication
(10) Pub. No.: US 2026/0370759 A1
(43) Pub. Date: Nov. 19, 2026

(54) System and Method for Artificial Intelligence based Enhanced Customer Service Experience

(71) Applicant: Amsiha Hira, Kowloon City (HK)

(72) Inventor: Amsiha Hira, Kowloon City (HK)

(73) Assignee: Skiphold Innovations Limited, Kowloon City (HK)

(21) Appl. No.: 19/207,287

(22) Filed: May 13, 2025

(51) Int. Cl. H04M 3/51; G06Q 10/0639; H04M 3/42; H04M 3/523

(52) U.S. Cl. CPC H04M 3/5166; G06Q 10/0639; H04M 3/42068; H04M 3/523

(57) ABSTRACT

The present invention is an intelligent telecommunication system for enhancing customer service experiences by using artificial intelligence to automate, optimize, and analyze customer interactions. The system predicts service demand and pre-emptively manages call queues, reducing wait times and improving responsiveness. It autonomously monitors IVR systems, dynamically updates a user-facing interface with available service options, and incorporates a user confirmation step before initiating live service calls to enhance customer service and minimize errors. The system places the user into a managed queue, where the AI maintains engagement until a live connection is established, ensuring a seamless transition to the customer service representative. The system then captures detailed interaction metrics, such as hold duration and call flow behavior. Altogether, the platform combines real-time decision-making, predictive logic, and performance feedback to deliver a faster, smarter, and more personalized customer service experience.

### CROSS REFERENCES TO RELATED APPLICATION

This application claims the benefit of U.S. Provisional Patent Application No. 63/564,996 on March 14, 2024, entitled “System and Method for Artificial Intelligence based Enhanced Customer Service Experience” the entire contents of which are hereby incorporated by reference.

### BACKGROUND OF THE INVENTION

### 1. Field of the Invention

The present invention relates to the field of telecommunication systems, specifically an advanced telecommunication system designed to enhance the interaction between consumers and customer service centers through the use of Artificial Intelligence (AI) and data analytics.

### 2. Description of the Related Art

In the realm of telecommunication, particularly in customer service interactions, consumers frequently face the daunting challenge of lengthy wait times and inefficient call management systems. This pervasive issue stems from traditional queuing mechanisms and Interactive Voice Response (IVR) systems, which, despite their intentions to streamline call routing, often result in prolonged periods of inactivity for the caller. The frustration and dissatisfaction arising from these delays can significantly impact the overall customer experience, highlighting the need for a drastic change in how calls are managed and serviced. The technical problem, therefore, lies in the inability of current systems to effectively anticipate consumer demand, manage call queues dynamically, and engage consumers in a meaningful way during their wait.

Existing solutions have attempted to address these challenges through advanced queuing techniques, customer callback features, and sophisticated IVR systems designed to facilitate quicker connections to service representatives. While these approaches offer some relief, they largely operate on reactive principles, addressing consumer demand as it unfolds rather than predicting and preparing for it in advance. Additionally, these systems offer limited flexibility in adapting to real-time fluctuations in call volume and fail to provide engaging activities for consumers during their wait time. This results in a service experience that, although slightly improved, remains fundamentally unchanged in terms of efficiency and consumer satisfaction.

Therefore, owing to the lack of proactive queue management and customer engagement strategies, it is necessary to devise a solution to address the core deficiencies of current solutions.

### BRIEF SUMMARY OF THE INVENTION

The present invention embodiments of the present disclosure present technological improvements as solutions to one or more of the above-mentioned technical problems recognized by the inventor in conventional solutions.

The present invention relates to a computer-implemented method and a system for automated call management for customer service interactions. The Artificial Intelligence Pre-Connected (AIPC) system revolutionizes customer service interactions through advanced AI algorithms that predict consumer demand, manage call queues efficiently, and reduce wait times significantly. By preemptively establishing communication channels between consumers and service providers, the AIPC system enhances the overall customer experience. It incorporates a user-friendly interface for service preference inputs, a sophisticated AI Process Manager for demand forecasting and queue optimization, and a robust Telephony System for call execution. Additionally, it introduces a confirmation mechanism that allows users to verify service intent before connection and offers a “Hold on Hold” feature enabling users to temporarily pause their queue position without disconnection. Interactive and Interactive elements remain part of the system, further increasing user engagement during wait periods.

The present invention aims to reduce customer wait times by implementing dynamic and predictive queue management, using AI algorithms trained on historical and real-time interaction data of the company's call logs. It enhances the overall efficiency of customer service interactions by automating IVR navigation, minimizing manual input, and enabling quicker access to live representatives. The system further improves communication continuity by maintaining AI presence throughout the call life cycle, ensuring seamless hand-off between automated processes and human users. The AI also adapts its call-handling strategies based on ongoing system performance and user preferences.

The invention also seeks to empower users by introducing a confirmation mechanism before connecting service calls, reducing unintended call placements, and offering greater control. Service quality is continuously optimized by capturing and analyzing detailed call behavior, including hold durations and customer engagement metrics, and using this data to generate performance dashboards and alerts. The analytics engine evaluates trends such as peak hold times and frequency of delays, triggering real-time notifications if thresholds are breached. By closing the loop between real-time operation and data-driven refinement, the invention enables intelligent service adaptation, improving responsiveness, accuracy, and customer satisfaction.

Present invention allows customers to use Voice over Internet Protocol (VoIP), also known as IP telephony to call the IVR services of any nation from their home-country. Users can view the estimated wait time to connect with a representative, allowing them to reserve a slot in advance. They will receive a notification when it is their turn to be attended to.

### BRIEF DESCRIPTION OF THE DRAWINGS

FIG. 1. depicts a block diagram of a system architecture for AI-based customer service management,

FIG. 2. depicts a block diagram of a process flow for predictive call handling and user engagement.

FIG. 3. depicts a block diagram of a post-call analytics module for hold time monitoring and reporting.

### DETAILED DESCRIPTION OF THE INVENTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

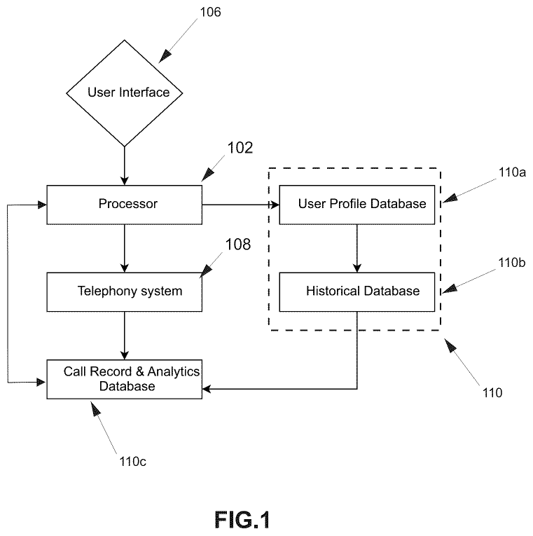

FIG. 1 depicts a block diagram of a system architecture for AI-based customer service management, 100 as per the disclosed invention. System 100 comprises a processor 102, communicably coupled to a memory for storing instructions that, when executed by the processor 102, perform one or more operations. The processor 102 is further connected to a user interface 106, a telephony system 108, and a network of connected databases 110 that further comprises a user profile database 110a, a preference management database 110b, a historical database 110c, and a call records & analytics database 110d.

The Processor 102 comprises a sophisticated artificial intelligence module responsible for real-time decision-making and optimization of the call management process. It draws on user data and historical interaction patterns to predict and pre-emptively manage call demand, allocate resources, and optimize the user's position in the call queue. It utilizes advanced algorithms to anticipate user demand based on historic events, and call logs and optimize the call queue, effectively reducing wait times. Additionally, it includes interfacing modules that ensure smooth communication between the various components of the system 100.

The User Interface 106 enables a user, through a dedicated application interface(e.g., a downloadable mobile application) to input their preferences initiate the call management process, and establish a communicative channel with the processor 102. It is designed to be intuitive and responsive, ensuring users can easily input their preferences and requirements for customer service interaction.

The telephony system 108 comprises the infrastructure that executes the actual dialing, queuing, and connection processes as directed by the AI Process Manager. This system is crucial for establishing and maintaining communication links between the user and customer service representatives. It comprises a call routing module, a call management database, and an interactive voice response. This is crucial for the operational execution of the system's commands, facilitating voice and data transmission necessary for connecting users with customer service representatives.

Further, the User Profile Database 110a is a repository of user-specific data and interaction histories. Further, the User Profile database stores user settings and Customization Options. This database is critical for personalizing the user experience and ensuring that the processor 102 tailors its operations to meet individual user needs effectively. Furthermore, the Historical Database 110b, complementing the User Profile Database 110a, archives all past call patterns and interactions across the user base. The insights derived from this data are integral to refining the AI algorithms that predict user behavior and optimize the system's call management strategies. Furthermore, the call record & analytics database 110c captures detailed records of every call made through the system as well as performance metrics. This database is vital for conducting comprehensive analysis of call patterns, durations, and outcomes, which further inform the processor's predictive modeling and decision-making processes.

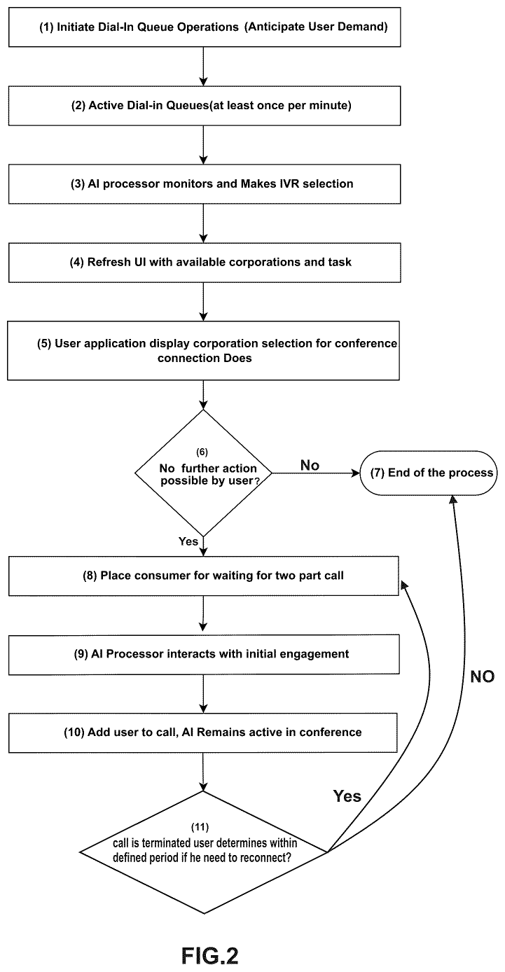

At the core of FIG. 2 lies the User Interface 106, representing the initial point of contact for consumers interfacing with the system 100. The user's actions and preferences are captured and stored within the User Profile Database (DB) 110a, which maintains a comprehensive record of individual user behaviors, preferences, and historical interactions. The Processor 102 is an advanced artificial intelligence module responsible for orchestrating the overall system functionality. It dynamically interacts with various components of the system to deliver a tailored and efficient user experience. Processor 102 is configured to leverage machine learning algorithms and predictive analytics to adapt the system's response to user needs in real-time.

The Telephony System 108, another critical component, is the medium through which the actual call and communication operations are conducted. It includes the infrastructure for dialing out to customer service centers, managing queues, and establishing connections as per the AI Process Manager's directives. Two databases complement the Telephony System 108: the Historical Database 110b and the Call Records & Analytics Database 110c. The Historical Database 110b archives all past user interactions, providing a valuable repository of data that the AI utilizes to predict future behaviors and optimize the system's call management strategies. The Call Records & Analytics Database 110c captures detailed records of every call made through the system, enabling comprehensive analysis of call patterns, durations, and outcomes. This data is vital for refining AI algorithms and enhancing system performance. The interplay between the processor 102 and these databases allows for a dynamic feedback loop where the processor 102 learns from each interaction, adjusting its processes for improved efficiency. The processor's decision-making is informed by a continuous stream of data, ensuring that each user's experience is personalized and optimized based on their specific history and the collective intelligence gathered by the system.

In operation, as depicted in the flowchart of FIG. 2, the process commences at step 1, where the processor 102 initiates dial-in queue operations. The Processor 102 anticipates user demand by generating demand forecasts. This is a predictive step wherein the processor 102 evaluates historical data, current trends, and other relevant variables to forecast the expected demand for customer service resources. Proceeding to step 2, the processor 102 activates the dial-in queues at regular intervals, at least once per minute, setting in motion the call placement mechanism. This frequency ensures that the system is responsive and dynamic, aligning with real-time user requirements. At step 3, processor 102 continually monitors the process and makes intelligent IVR selections based on predefined algorithms. These selections are critical for navigating the corporate IVR systems and directing the call toward the appropriate queue or service option. Simultaneously, in step 4, the user interface 106 is refreshed to display the most current list of available corporations and tasks, enabling users to make informed choices about the desired service interaction. Upon user interaction, as depicted in step 5, the application displays a selection of corporations for the user to initiate a conference connection. If the user selects a company, the process advances to step 8; otherwise, it moves to step 6, where no further action is possible by the user, leading to the end of the process at step 7. In step 8, upon user confirmation, the consumer is placed in a waiting queue for a two-party call, positioning them to engage with the customer service representative. At the initial engagement in step 9, the processor 102 interacts, simulating a human user's responses to ensure the call is maintained within the active queue until the user is ready to join. Step 10 involves adding the user to the call while the processor 102 remains active in the conference. This feature ensures that the transition from the AI to the human user is seamless and that the quality of the call is maintained throughout the conversation. Finally, in step 11, if the call is terminated, the user has the option within a specified time frame to determine if they require reconnection. This contingency measure accounts for inadvertent disconnections or unfinished queries, providing an additional layer of user assurance.

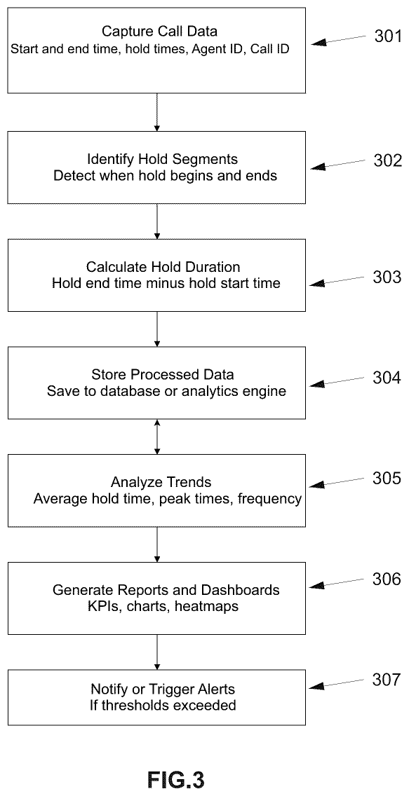

Continuing from the earlier embodiments, FIG. 3 illustrates a specialized component of the system focused on post-call analysis and Performance monitoring, particularly addressing customer hold time management. This analytical feature enables the AI engine to refine and enhance future interactions based on real-time and historical call behavior. The process begins with capturing call data 301, where the system gathers essential information such as call start and end times, hold durations, agent identifiers, and unique call session IDs. This data is sourced directly from the telephony system 108 and forms the input for downstream analysis.

Next, the system executes Identity Hold Segments 302 to detect when users are placed on hold and when those hold sessions end. This distinction provides a precise mapping of inactive call phases, which are critical for assessing system responsiveness and agent performance. This is followed by hold duration calculator 303, where the system computes the length of each hold event by calculating the difference between the hold start and end times. The data of calls and waiting time durations are associated with specific call IDs in the logs. The resulting metrics are then passed to memory to store processed data 304, where they are securely archived in the call record & analytics database 110c. This ensures the availability of structured data for ongoing reference, analysis, and performance assessment. To extract broader insights, the system analyzes trends 305 using AI algorithms, it examines patterns such as average hold times, time-of-day congestion, and high-frequency delay scenarios. This process is informed by cross-referencing current call data with historical trends stored in the database 110b. The results of this analysis are presented through report generation dashboard module 306. These visual tools include Key Performance Indicators (KPIs) like time series charts, visual and heat-maps, which provide a comprehensive view of system efficiency and customer wait experiences. The dashboards are designed to assist supervisors and technical administrators in identifying bottlenecks and measuring service quality.

If certain performance thresholds are exceeded such as when hold times surpass acceptable limits, the system notifies the user through notify or alert trigger module 307. These alerts can notify administrators or automatically initiate predefined mitigation actions to prevent system failure, such as rerouting calls, increasing agent availability, or adjusting IVR behavior in real-time. The system completes a critical feedback loop. It doesn't merely respond to service demand but learns from every interaction, enabling proactive adjustments and continuous optimization. This makes the AI processor 102 not just a call routing tool, but a central decision-making engine capable of elevating the overall quality and consistency of customer service delivery.

Utilizing advanced AI algorithms, the system predicts peak call times and pre-dial calls in anticipation of user demand. This predictive approach allows for efficient allocation of telecommunication resources, reducing the wait time for users. The system is capable of dynamically navigating through changing IVR menus and interacting with voice-activated systems, mimicking human understanding and response. This feature significantly enhances the user experience by reducing the time and effort required to reach a live agent. Unique to this system are features such as ‘Hold on Hold’ and ‘Queue Progress Conservation’. Users can temporarily pause their position in the queue or save their progress in case of a disconnection, thereby offering flexibility and convenience. In every call, the system remains an active participant, ensuring quality control, detecting disconnections, and offering additional services such as rapid re-connection and post-call assistance. The system's AI-driven process management ensures scalability and robustness, capable of adjusting its operations based on real-time demand and system health. The invention is designed with a deep understanding of consumer needs, offering features that cater to both premium and non-premium users, thereby democratizing access to efficient customer service experiences.

What is claimed is:

1. A computer-implemented system for managing and optimizing customer service interactions using artificial intelligence, comprising:
(a) a processor configured to execute AI-driven demand forecasting and call prediction logic;
(b) a user interface configured to collect service preferences;
(c) a telephony system configured to initiate, manage, and transfer calls;
(d) one or more databases comprising:
(I) a user profile database storing individual user preferences and histories,
(II) a historical database archiving aggregated interaction patterns across users,
(III) a call records and analytics database capturing call metadata, hold durations, and performance metric;
(e) wherein the processor is configured to:
(f) predict customer service demand based on historical data and initiate dial-in queue operations pre-emptively,
(g) autonomously interact with IVR systems to maintain call presence and navigate service menus,
(h) dynamically update the user interface to reflect available service providers and real-time call opportunities,
(i) facilitate a seamless transfer of control from the AI system to the user during live calls,
(j) analyze post-call data including hold time patterns, and
(k) generate alerts or reports when performance thresholds are exceeded.

2. The system of claim 1, wherein the processor initiates outbound calls at regular intervals of at least once per minute to align with predicted customer demand.

3. The system of claim 1, wherein the telephony system maintains active call presence by allowing the AI to simulate caller interactions until the user joins.

4. The system of claim 1, wherein the user interface displays an updated list of corporations and service options based on the processor's real-time IVR navigation and queue status.

5. The system of claim 1, wherein the processor, upon user confirmation, transitions a waiting call to a two-party connection and remains in conference to monitor the interaction.

6. The system of claim 1, wherein the user is provided an option to reconnect to a previously disconnected call and reclaim the queue position within a pre-defined time frame.

7. The system of claim 1, wherein the processor is further configured to:
(a) extract start and end times, user identifiers, and hold segments from call data,
(b) compute hold duration,
(c) archive such metrics in the call records and analytics database, and
(d) use this data for longitudinal service optimization.

8. The system of claim 7, wherein trend analysis includes identifying average hold time, peak delay intervals, and frequency of extended holds.

9. The system of claim 7, wherein the system is configured to generate visual dashboards including key performance indicators, heat-maps, and comparative charts.

10. The system of claim 7, wherein the system issues real-time alerts to system administrators or initiates mitigation actions when predetermined performance thresholds are exceeded.

11. The system of claim 1, wherein the processor adapts queue prioritization logic in real-time based on continuously updated call behavior patterns and system performance metrics.
